(19) United States
(12) Patent Application Publication
(10) Pub. No.: US 2026/0274474 A1
(43) Pub. Date: Sep. 17, 2026

(54) METHOD FOR MAKING FLAT BOX BLANKS AND METHOD FOR PACKAGING PRODUCTS

(71) Applicant: Fameccanica.Data S.p.A., San Giovanni Teatino Chieti (IT)

(72) Inventors: Diego GUALTIERI, San Giovanni Teatino Chieti (IT); Alessandro CIPRIANI, San Giovanni Teatino Chieti (IT)

(21) Appl. No.: 18/873,804

(22) PCT Filed: Jun. 7, 2023
(86) PCT No.: PCT/IB2023/055855

§ 371 Date: Dec. 11, 2024

(30) Foreign Application Priority Data
Jun. 14, 2022 (IT) 102022000012536

(51) Int. Cl. B65B 5/02; B31B 50/59; D21J 3/12

(52) U.S. Cl. CPC B65B 5/02; B31B 50/59; D21J 3/12

(57) ABSTRACT

A method for producing flat box blanks, wherein an array of unbound loose fibers shapes is formed, the unbound loose fibers shapes are wetted, and the unbound loose fibers shapes are compressed to form an array of flat box blanks

### FIELD OF THE INVENTION

The present invention refers generally to the packaging sector, in particular, to the packaging of consumer products.

In particular, the invention relates to a method for producing flat box blanks.

The invention was developed, in particular, with a view to packaging products to be distributed through e-commerce channels.

A possible embodiment also relates to a method for packaging consumer products.

### TECHNOLOGICAL BACKGROUND

With the ever-increasing diffusion of e-commerce, the customization of packaging is becoming more and more important.

While mass distribution requires standard packages containing a relatively large, fixed number of a single product type, e-commerce distribution systems require a small number of products to be packaged in highly customized packages corresponding to the end customer's order. Typically, an e-commerce order comprises different types of products, with a variable number of products for each type of product.

Automated packaging units used for packaging consumer products for mass distribution lack the flexibility required for e-commerce distribution.

For e-commerce distribution of consumer products, individual products or groups of products are often packaged in cardboard boxes. Cardboard and paper are the most sustainable materials as they are biodegradable and completely recyclable.

However, packaging consumer products into cardboard boxes poses significant problems.

E-commerce shipping centers have a plurality of packing stations to which flat blanks are supplied, in a relatively small number of standard sizes. At packaging stations, the flat blanks are folded to form the boxes, the products are placed into the boxes, the boxes are closed and shipping labels are applied to them.

The dimensions of the packaging must necessarily be oversized compared to the volume of the products to be packaged. This leads to a high transport inefficiency and a waste of packaging material as parts of the packages, often considerable parts, are empty. In many cases the boxes are extremely oversized compared to the actual volume of the products they contain.

Inefficient transportation and wasted packaging material are compounded in that manufacturers the flat blanks tend to reduce the number of different formats to reduce costs.

In addition, the flat blanks are produced in paper product production plants, stacked on pallets, and transported to e-commerce shipping centers, where they are stored while awaiting use.

All these aspects have a negative impact on sustainability and on packaging and shipping costs.

US2017341795A1 discloses a packaging system wherein articles can be packed for shipping or storage using additive manufacturing techniques, also known as three-dimensional 3-D printing.

U.S. Pat. No. 3,857,657A discloses an apparatus for forming pads of wet pressed cellulose fibers including a conveyor belt on which fibers are deposited, and a stationary suction device positioned on the lower surface of the belt to create a vacuum across sets of perforations of the moving belt.

US2010190020A1 discloses an airlaid material, and a method for producing three-dimensional shaped packaging prepared from airlaid fluff, comprising natural fibers and selected amounts of thermoplastic materials, adhesive materials and thermosetting resin, where the thermoplastic fibers and/or adhesive resin and/or thermosetting resin during hot presssing with water cause a bond between the fibers.

US2018215117A1 discloses an apparatus for forming customized cardboard on demand, to form individually designed packaging boxes, wherein the cardboard has at least one corrugated layer sandwiched between two flat layers.

### OBJECT AND SUMMARY OF THE INVENTION

The object of the present invention is to provide a method for producing flat box blanks, and a method for packaging consumer products, which overcome the drawbacks and limitations of the prior art.

Another object of the present invention is to provide a packaging method that has improved sustainability with respect to prior art solutions, in particular regarding a lower use of packaging material and better transport efficiency.

According to the present invention, these objects are achieved by a method for producing flat box blanks having the characteristics of claim 1, and by a method for packaging consumer products having the characteristics of claim 10.

Optional characteristics of the invention form the subject of the dependent claims.

The claims form an integral part of the disclosure provided here in relation to the invention.

### BRIEF DESCRIPTION OF THE DRAWINGS

Further characteristics and advantages of the invention will become clear from the detailed description that follows, given purely by way of non-limiting example, with reference to the attached drawings, in which:

FIG. 1 is a schematic view of a packaging System according to an embodiment of the present invention,

FIGS. 2-5 are schematic plan views showing the formation sequence of a flat box blank,

FIGS. 6, 7 and 8, 9 are schematic views showing two examples of boxes and corresponding box blanks, and

FIG. 10 is a schematic view of another embodiment of a packaging system according to the present invention.

It will be appreciated that the accompanying drawings are schematic and that some components may not be shown for a better understanding of the figures. It will be appreciated that the various figures may also not be represented on the same scale.

### DETAILED DESCRIPTION

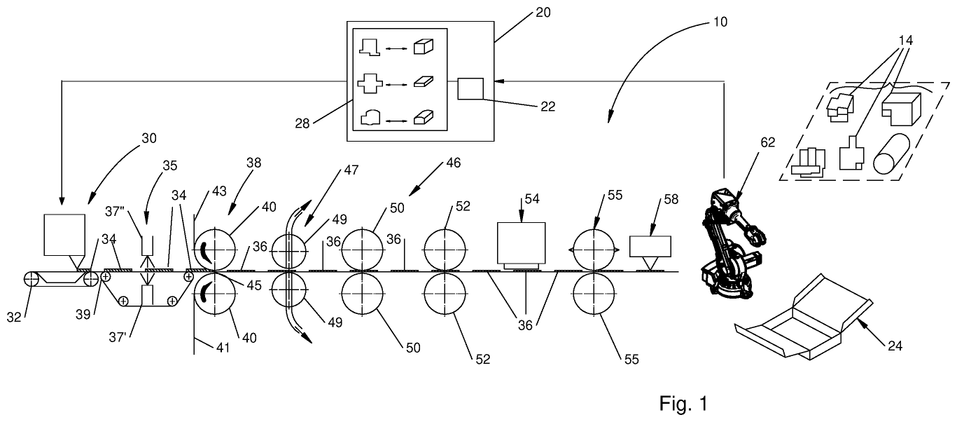

With reference to FIG. 1, a packaging system for packaging consumer products is indicated by the reference number 10.

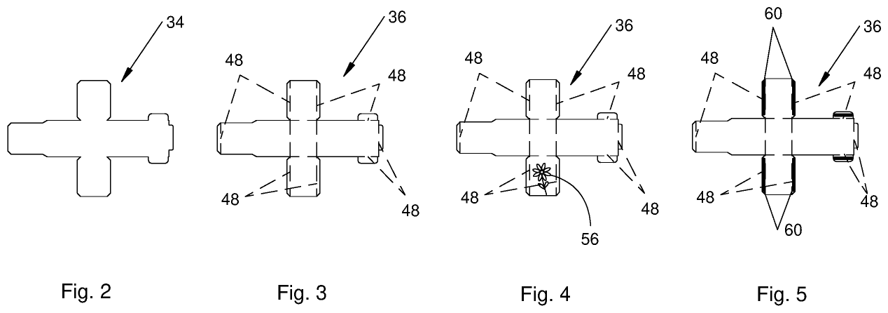

The packaging system 10 comprises a fiber deposition apparatus 30 configured to deposit unbound loose fibers on a movable support 32, for example, cellulose fibers, so as to form loose fiber shapes 34. FIG. 2 shows a loose fiber shape of 34 as they leave the fiber deposition apparatus 30.

The fiber deposition apparatus 30 may be configured to project unbound loose cellulose fibers by jets of pressurized air. The movable support 32 onto which the unbound loose cellulose fibers are projected may be a porous tape, for example, felt, pneumatically connected to a suction source.

The fiber deposition apparatus 30 may be a 3D-Lofter manufactured by the company Dilogroup. A 3D-Lofter is a machine for forming strips of fibers, which distributes the fibers three-dimensionally on a movable surface according to a programmable deposition pattern. The 3D-Lofter uses high pressure jets of air to convey the fibers, and deposit them with precision on a porous mobile support connected to a suction source.

The fiber deposition apparatus 30 may be controlled by an electronic control unit 20, which may be programmed to select the loose fiber shape to be formed 34 according to information about the product or group of products to be packaged, so as to produce customized boxes based on the characteristics of the product or group of products to be packaged, as described in detail in European patent application 21212279.0 by the same Applicant.

The product information provided to the electronic control unit 20 may include dimensions and/or weight of the products or groups of products and any other information relevant to the composition of the shipping package. The electronic control unit 20 may receive product information from an e-commerce server, which receives orders from an e-commerce network. Each order may comprise different types of products and a variable number of products for each type of product. The electronic control unit 20 may also receive product information from code readers, from automatic stock units that supply products or groups of products based on shipping orders, or from any other source of product information.

The electronic control unit 20 may also receive shipping information such as name and address of the recipient of the parcel, as well as information on the aesthetic characteristics of the parcel, for example, messages to be printed on the parcel, decorative elements, etc. which can be selected by the customer when ordering.

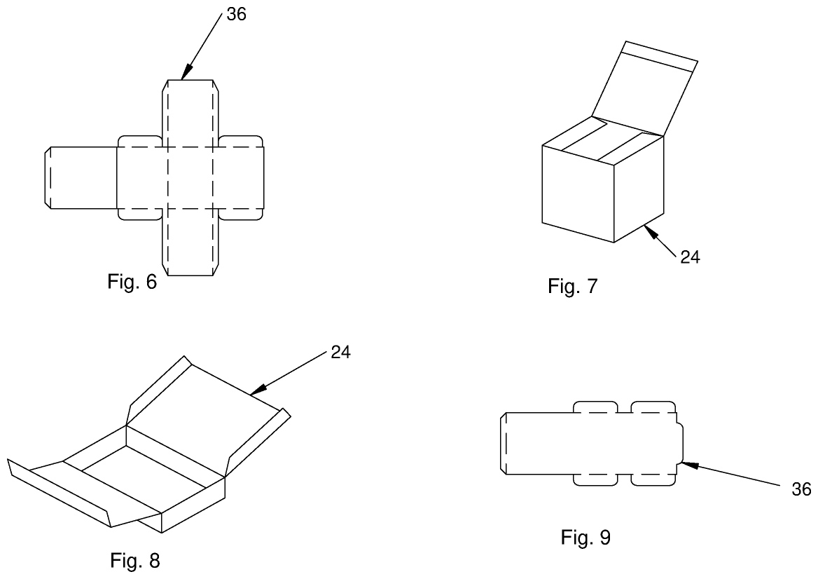

The electronic control unit 20 may have a data storage memory 22 wherein data of a plurality of box models are stored. The data of the plurality of box models may include data on flat box blank models corresponding to the respective box models. The data storage memory 24 may hold data of hundreds or thousands of different box models suitable for a multitude of different products and groups of products. By way of example, FIGS. 6, 8 and 7, 9 show two examples of possible box models 24 and respective flat box blanks 36.

The electronic control unit 20 may comprise a processing unit 28 wherein software is installed, configured to select a box design from the plurality of box models 24 and respective flat box blanks 36 stored in the data storage memory 22, said box design being configured for the product or group of products to be packaged. The processing unit 28 may perform the selection of the box model 24 and the respective flat box blank 36 based on the product information received. In particular, the processing unit 28 selects the design of the box 24 with the smallest possible dimensions necessary to contain the product or group of products to be packaged. The selection of the design of the box 24 aims to minimize the empty volume of the packaging, and the amount of packaging material. In choosing the design of the box 24, the processing unit may consider the customer's preferences, which may possibly be contained in the order.

The electronic control unit 20 sends the fiber deposition apparatus 30 instructions for depositing the unbound loose fibers on the movable support 32, in a shape corresponding to the flat box blank 36 selected by the processing unit 28, based on the information on the product or group of products. The fiber deposition apparatus 30 may produce an array of loose fiber shapes 34, each one different from the previous one, customized for each specific shipment order.

At the outlet of the fiber deposition apparatus 30, the loose fiber shapes 34 may have a basis weight of between 600 and 900 gsm.

The packaging system 1 comprises a wetting unit 35 arranged downstream of the fiber deposition apparatus 30, and configured to wet the loose fiber shapes 34 at the outlet of the fiber deposition apparatus 30. The liquid used to wet the loose fiber shapes 34 at the outlet of the fiber deposition apparatus 30 may be water or a water-based mixture. The wetting unit 35 may comprise two nozzles 37′, 37″ arranged to wet the opposite surfaces of the loose fiber shapes 34.

In a possible embodiment, a quantity of liquid ranging from 50 to 200 ml/m² is dispensed onto the of unbound loose fiber shapes 34.

The packaging system 1 may comprise a conveyor with a mesh belt 39 that supports the loose fiber shapes 34 as they pass through the wetting unit 35.

After the wetting step, the loose fiber shapes 34 are compressed to form flat box blanks 36 (FIG. 3).

With reference to FIG. 1, the compression of the loose fiber shapes 34 is accomplished by passing the loose fiber shapes 34 into a pressing unit 38. The pressing unit 38 may comprise a pair of pressing rollers 38, which compress the loose fiber shapes 34 into a compression nip 45.

The pressing unit 38 may compress the loose fiber shapes 34 with a pressure between 3 and 30 bar. The pressure rollers 38 may be heated to a temperature of between 20° C. and 200° C.

At least one continuous flexible web 41 may be applied to at least one of the surfaces of the loose fiber shapes 34. The continuous flexible web 41 may be applied on at least one of the surfaces of the loose fiber shapes 34 before the compression step or during the passage of the loose fiber shapes 34 between the pressure rollers 38. In a possible embodiment, the loose fiber shapes 34 may be sandwiched between two continuous flexible webs 41, 43. In the example illustrated in FIG. 1, the two continuous flexible webs 41, 43 are fed onto the surfaces of the respective pressure rollers 38 upstream of the compression nip 45.

The continuous flexible webs 41, 43 may consist of tissue paper sheets with a basis weight ranging from 10 to 40 gsm. In possible embodiments, the continuous flexible webs 41, 43 may consist of non-woven webs formed from natural or synthetic fibers, with a basis weight ranging from 500 to 900 gsm.

After the step of compressing the loose fiber shapes 34, blanks of flat boxes 36 are obtained having the mechanical strength necessary for forming boxes for packaging.

The wetting of the unpressed loose fiber shapes 34 promotes penetration of the liquid between the fibers, since the fibers are more open before the compression step. The tensile strength of the thus obtained flat box blanks 36 is in the order of 2-6 N/mm for fiber mats with a basis weight of 800 gsm, with a liquid dispersion of 100 ml/m² and a compressive pressure of 25 N/cm^{2 .}

Wetting the loose fiber shapes 34 before pressing is advantageous in the case in which webs 41, 43 of tissue paper or other materials are used. Indeed, pressing after applying liquid on the fibers promotes adhesion and bonding between the webs 41, 43 and the fibers of the shapes 34. A multilayer structure thus created may reach a tensile strength of 6-10 N/mm.

Another advantage is that wetting the fibers before compression makes it possible to obtain a more compact and thinner product, with a thickness between 0.5 and 2 mm, with a compression pressure of 20/30 N/cm², while if pressing is carried out before, i.e. at the application of the liquid at the same compression pressure, products with a thickness of 2-4 mm are obtained.

After the compression step, the flat box blanks 36 may be passed into a liquid removal unit 47 in which the liquid remaining in the fibers after compression is removed. The liquid removal unit 47 may comprise a pair of pressure rollers 49 connected to a suction source.

Referring to FIGS. 1 and 3, after consolidation of the loose fiber shapes 34 into a flat box blank 36, the flat box blanks may be creased in a creasing unit 46 to form fold lines 48. The creasing unit 46 may comprise first creasing rollers 50 for forming fold lines in the machine direction, and second creasing rollers 52 for forming fold lines in the direction transverse to the machine direction.

With reference to FIGS. 1 and 4, the flat box blanks may pass through a printer 54 configured to print prints 56 of different types on selected areas of the flat box blank 36, e. g. barcodes containing shipping information, manufacturer or distributor logos, personalized messages selected by the customer, decorative images, etc.

The packaging system 1 may comprise a cutting unit 55 for transverse cutting of the continuous webs 41, 43, so as to form flat box blanks 36 separated from each other.

Referring to FIGS. 1 and 5, the flat box blanks 36 may pass through a glue dispenser 58 configured to apply glue layers 60 to selected areas of the flat box blanks 36.

Referring to FIG. 1, the packaging system 10 may comprise a robot 62 configured to automatically assemble the flat box blanks 36 to form finished boxes 24. The robot 62 may operate according to instructions provided by the electronic control unit 20. Alternatively, the assembly of the flat box blanks 36 into the final boxes 18 may be carried out manually.

A product 14 or a group of products 14 is then inserted into the personalized box 24, and then the box 24 is closed. Insertion of the product 14 or group of products 14 into the personalized box 24 be performed by the same robot 62 that assembles the boxes 24. Instructions for inserting the product 14 or group of products 14 into the personalized box 24 may be provided by the electronic control unit 20. Alternatively, insertion of the product 14 or group of products 14 into the personalized box 24 may be carried out by a dedicated robot, or manually.

The main advantages of this solution are as follows:
extreme flexibility in forming the packaging boxes;
the volume and shape of the boxes are adapted to the content, to minimize waste of packaging material and to optimize transport efficiency;
elimination of transportation and storage of flat box blanks.

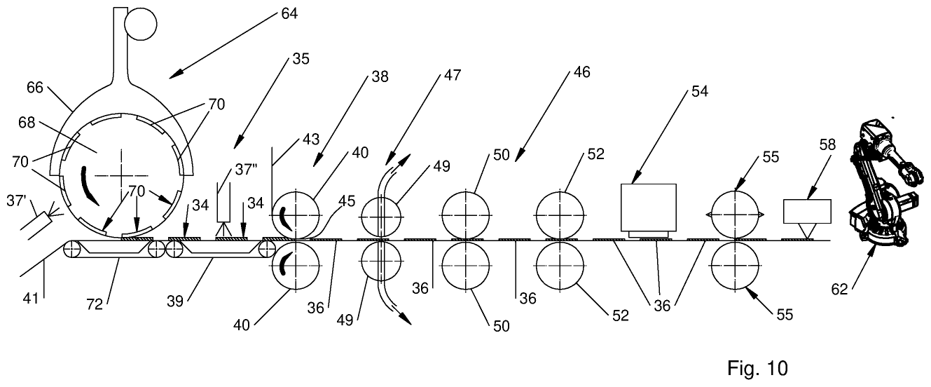

FIG. 10 illustrates a second embodiment of a packaging system 10 according to the present invention. The elements corresponding to those previously described are indicated with the same numerical references.

In the embodiment of FIG. 10, the fiber deposition apparatus 30 of the embodiment of FIG. 1 is replaced by a forming unit 64 comprising a forming chamber 66 containing loose fibers (for example, cellulose fibers) facing a forming wheel 68 provided on its outer surface with recesses 70 in which unbound loose fibers are deposited. The recesses 70 may be connected to a suction source to retain the unbound loose fibers by suction.

The recesses 70 of the forming wheel 68 have the same shape as the unbound loose fiber shapes 34 that are to be produced. The unbound loose fibers shapes 34 are extracted from the recesses (for example, by air jets), and deposited on a conveyor 72.

Also in the embodiment of FIG. 10, the packaging system 10 comprises a wetting unit 35 configured to wet the loose fiber shapes 34. The wetting unit 35 may comprise a first nozzle 37′ arranged to wet the loose fiber shapes 34 located in the recesses 70 of the forming wheel 68, and a second nozzle 37″ arranged to wet the loose fiber shapes 34 at the outlet of the forming wheel 68. The nozzles 37′, 37″ spray respective jets of fluid onto opposite surfaces of the loose fiber shapes 34.

After the wetting step, the loose fiber shapes 34 are compressed in a pressing unit 38, as in the embodiment of FIG. 1.

In a possible embodiment, a first flexible web 41 of tissue paper or non-woven fabric may be fed between the forming wheel 68 and the conveyor 72, so that the loose fiber shapes 34 are deposited on the first flexible web 41. In a possible embodiment, a second flexible web 43 of tissue paper or non-woven fabric may be applied to the loose fiber shapes 34 before the compression step or during the passage of the loose fiber shapes 34 between the pressure rollers 38.

After the compression step, the process steps of the packaging system of FIG. 10 are the same as those described in the embodiment of FIG. 1.

In the embodiment of FIG. 10, to vary the shape of the loose fiber shapes 34, it is necessary to replace the forming wheel 68. Therefore, this solution is more suitable in the case wherein successive batches of boxes with the same shape are produced.

A possible embodiment regards a packaging system, comprising:
a forming device 30, 64 configured to form an array of unbound loose fiber shapes 34,
a wetting unit 35 configured for wetting said unbound loose fiber shapes 34, and
a compression unit 38 arranged downstream of the wetting unit 35 and configured to compress said unbound loose fibers shapes 34 and form an array of flat box blanks 36.

In a possible embodiment, the packaging system comprises:
a robot 62 configured for folding said flat box blanks 36 to form boxes 24, and
a packaging station configured to package products 14 or groups of products 14 into said boxes 24.

Of course, without prejudice to the principle of the invention, the details of construction and the embodiments can be widely varied with respect to those described and illustrated, without thereby departing from the scope of the invention as defined by the claims that follow.

1. A method for producing flat box blanks, comprising:
forming an array of unbound loose fibers shapes
wetting said unbound loose fibers shapes, and
compressing said unbound loose fibers shapes and forming an array of flat box blanks.

2. The method of claim 1, wherein said unbound loose fibers shapes are formed by projecting unbound loose fibers by pressurized air jets onto a surface of a movable support fluidly connected to a suction source.

3. The method of claim 1, wherein said unbound loose fibers shapes are formed by arranging loose fibers in a forming chamber facing a forming wheel provided with recesses on one of its outer surfaces, and depositing unbound loose fibers into said recesses.

4. The method of claim 1, wherein at the an outlet of the a fiber deposition apparatus, said unbound loose fibers shapes have a basis weight comprised between 500 and 900 gsm.

5. The method of claim 1, wherein wetting said unbound loose fibers shapes includes a quantity of liquid comprised between 50 and 200 ml/m² being dispensed onto said unbound loose fibers shapes.

6. The method of claim 1, wherein said unbound loose fiber shapes are compressed between a pair of pressure rollers at a pressure comprised between 3 and 30 bar.

7. The method of claim 6, wherein said pressure rollers are heated to a temperature comprised between 20 C. and 200 C.

8. The method of claim 1, comprising applying a continuous flexible web on at least one surface of the unbound loose fibers shapes.

9. The method of claim 8, comprising sandwiching the unbound loose fibers shapes between two continuous flexible webs.

10. A method for packaging products, comprising:
forming an array of unbound loose fibers shapes,
wetting said unbound loose fibers shapes,
compressing said unbound loose fibers shapes and forming an array of flat box blanks,
folding said flat box blanks to form boxes, and
packaging products or group of products into said boxes.
